(19) United States
(12) Patent Application Publication
(10) Pub. No.: US 2011/0302843 A1
(43) Pub. Date: Dec. 15, 2011

(54) WINDOW DRIVE WITH BACK-CURVING CHAIN

(76) Inventors: Brian D. Dallmann, Owatonna, MN (US); Scot J. Berkley, Owatonna, MN (US)

(21) Appl. No.: 13/157,530

(22) Filed: Jun. 10, 2011

Related U.S. Application Data
(60) Provisional application No. 61/353,947, filed on Jun. 11, 2010.

(51) Int. Cl. E05F 15/04; F16G 13/02

(52) U.S. Cl. 49/358; 474/219

(57) ABSTRACT

A drive chain for a window or skylight operator. The chain is configured to define a rigid predetermined shape when flexed in a first direction, while still enabling the chain to be coiled for storage in a housing when flexed in the opposite direction.

### RELATED APPLICATIONS

This application claims the benefit of U.S. Provisional Patent Application Ser. No. 61/353,947, entitled WINDOW DRIVE WITH BACK-CURVING CHAIN, filed on Jun. 11, 2010, said application hereby fully incorporated herein by reference.

### FIELD OF THE INVENTION

The invention relates to operators for shiftable fenestration components and more specifically to motor or manually driven chain linkages for actuating windows or skylights.

### BACKGROUND OF THE INVENTION

Skylights and casement type windows are a popular option for allowing natural light to enter into an enclosed space. Commonly found in both residential and commercial settings, skylights and windows generally include a frame surrounding an operable sash with a pane of transparent or translucent material that enables the entry of sunlight while providing a physical barrier between the enclosed space and the outside environment when the sash is closed.

Window and skylight operators having a motorized drive and chain linkage are known. Examples of a chain operator can be seen in U.S. Pat. Nos. 4,382,349 and 4,521,993, and U.S. Provisional Application No. 61/187,920, each herein incorporated by reference. These operators employ a length of chain that can be stored within a casing of the operator. A distal end of the chain is secured to a movable sash. The rotation of a drive sprocket within the casing causes movement of the chain either into or out of the casing in order to position the movable sash connected to the distal end of the chain.

Prior art operators are generally configured so that the chain is secured to the sash on a side of the sash that is opposite from and parallel to the hinged side of the sash and the casing housing the operator mechanism is secured to the frame on the side that is also opposite from and parallel to the hinged side of the frame. The chain is sufficiently rigid when extended from the operator casing to push the sash outwardly away from the window frame to open the window. In this arrangement the chain must have some flexibility to follow the arc shaped path that the end of the sash opposite the hinge to which the chain is secured travels as the sash is opened and closed. Aside from this flexibility, the extended chain must be fairly rigid as it extends outwardly to push the sash open.

The positioning of the operator on the side opposite the hinge can present a problem, particularly in certain skylights. The width of a skylight is often constrained by the spacing of structural members in a roof. It is often desirable to fit the skylight between rafters or trusses that make up the roof structure. Otherwise, significant structural modification must be made to the roof structure to accommodate the skylight. The hinge is commonly on the upper side of the skylight and the axis of rotation of the hinge is perpendicular to the structural rafters or trusses. Thus the operator is positioned in the lower side of the skylight and the available width to accommodate the operator is constrained by the spacing of the structural members between which the skylight assembly must fit. This problem is especially acute when the spacing of the structural members is small, such as sixteen inches on center.

### SUMMARY OF THE INVENTION

The disclosed invention relates to systems and methods of a window operator including a drive chain configured to maintain a rigid shape when the window is in an open orientation while still allowing the chain to flex when retracted into a housing for storage thereby permitting closure of the window. The chain may take a back curving arcuate shape when extended. The chain in accordance with the invention may also be configured to follow a more complex path as it extends.

The drive chain in accordance with the invention, permits the links in the chain to coil about an axis that is parallel with the hinge axis when the drive chain is retracted within the operator housing as compared with the prior art wherein the drive chain coils about an axis perpendicular with the hinge axis. Some embodiments of the invention can be used to operate casement windows where the hinge axis is vertical.

In an example embodiment, a drive chain is formed by a plurality of links made up of plates joined together with offset pins generally in the form of a roller chain. The plates are configured such that the pins are offset from a central axis toward a flexing side of the drive chain. The plates present a rounded face on the flexing side of the drive chain. The opposite side of the plate generally is generally configured to present a flat face. The flat face of multiple links of the drive chain thereby defines a rigid curve or other rigid path when the chain is extended.

In one example embodiment, one edge of each plate includes a concave surface opposite a convex surface on the opposite edge. Both the concave and convex surfaces are disposed on the side of the central axis nearer the flat face of the plate. The concave surface of one link plate comes into apposition with the convex surface of an adjoining link plate to define a positional relationship between the link plates that makes the extended link plates together define a rigid curve. The curve created by the interaction of the link plates generally follows the arc of the path of travel of the location at which the drive chain is secured to the sash in one example embodiment.

The edges of the link plates are not limited to concave and convex but the abutting edge surfaces of adjacent link plates have complementary shapes to abuttingly interact so that the drive chain forms a rigid structure when extended. The drive chain of the invention also forms a desired shape when extended and follows a desired path as it extends.

By varying the shape of the edges of the link plates in the present invention the rigid shape that the drive chain assumes upon extension can be made to vary to other shapes beyond an arcuate curve. For example, the drive chain shape can be made to conform to an irregular sash opening path to permit best apposition of weather stripping between the sash and the frame. This can improve the weather tightness and energy efficiency of a window or skylight and reduce wear on weather stripping created by abrasion between the weather stripping and the surface that it seals against by reducing sliding of the weather stripping relative to the sealing surface.

Thus, in some embodiments the extended drive chain may include a combination of curved and straight sections of links or more and less curved sections such that the extended drive chain can be caused to follow a desired path upon extension.

In an embodiment, a drive chain includes a plurality of links, each link of the plurality of links pivotally coupled to at least one neighboring link of the plurality of links with a pin so as to form a chain. The chain further includes a plurality of shape-defining plates, each plate having a first edge and an opposing second edge, the plates coupled with the plurality of links such that the first edge of each plate is engaged with the second edge of a neighboring plate when the chain is flexed in a first direction, the engagement of the plates thereby defining a rigid predetermined shape for the chain. The edges of the plates may be disengaged when the chain is flexed in a second direction opposite the first direction, thereby enabling the chain to be coiled. In a further embodiment, the shape-defining plates are coupled on the outside of the links with the pins, each of which may be received in a bushing. The rigid predetermined shape may be arcuate, straight, or a combination with arcuate and straight sections. In an embodiment, the first edge of each plate may be convex and the second edge of each plate may be correspondingly concave.

In another embodiment, a drive chain includes a plurality of links, each link of the plurality of links pivotally coupled to at least one neighboring link of the plurality of links with a pin so as to form a chain, and shape-defining means coupled with the links for defining a rigid predetermined shape for the chain when the chain is flexed in a first direction. Structure corresponding to the shape-defining means may include a plurality of shape-defining plates, each plate having a first edge and an opposing second edge, the plates coupled with the plurality of links such that the first edge of each plate is engaged with the second edge of a neighboring plate when the chain is flexed in the first direction.

In another embodiment, an assembly for closing an opening in a structure includes a frame adapted to be received in the opening of the structure, a movable sash hinged to the frame, and a motorized operator assembly for moving the sash relative to the frame. The operator assembly includes a drive chain comprising a plurality of links, each link of the plurality of links pivotally coupled to at least one neighboring link of the plurality of links with a pin so as to form a chain, and a plurality of shape-defining plates, each plate having a first edge and an opposing second edge, the plates coupled with the plurality of links such that the first edge of each plate is engaged with the second edge of a neighboring plate when the chain is flexed in a first direction, the engagement of the plates thereby defining a rigid predetermined shape for the chain.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The embodiments of the present invention may be more completely understood in consideration of the following detailed description of various embodiments in connection with the accompanying drawings, in which:

FIG. 1 is a perspective view of a window assembly according to an embodiment of the invention;

FIG. 2 is another perspective view of the window assembly of FIG. 1;

FIG. 3 is a side view of a back-curving chain according to an embodiment of the invention;

FIG. 4 is a top view of a back-curving chain according to an embodiment of the invention;

FIG. 5 is another top view of the back-curving chain of FIG. 4;

FIG. 6 is another top view of an individual link of the back-curving chain of FIG. 4;

FIG. 7 is a top view of an individual link of the back-curving chain according to an embodiment of the invention;

FIG. 8 is a perspective view of a back-curving chain according to an embodiment of the invention;

FIG. 9A is a plan view of a drive chain segment according to an embodiment of the invention;

FIG. 9B is a plan view of a drive chain segment according to another embodiment of the invention;

FIG. 10 is a plan view of a drive chain segment according to an embodiment of the invention having an arcuate portion and a generally straight portion; and

FIG. 11 is a schematic depiction of an operator, drive chain and window according to an embodiment of the invention.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention as defined by the appended claims.

### DETAILED DESCRIPTION

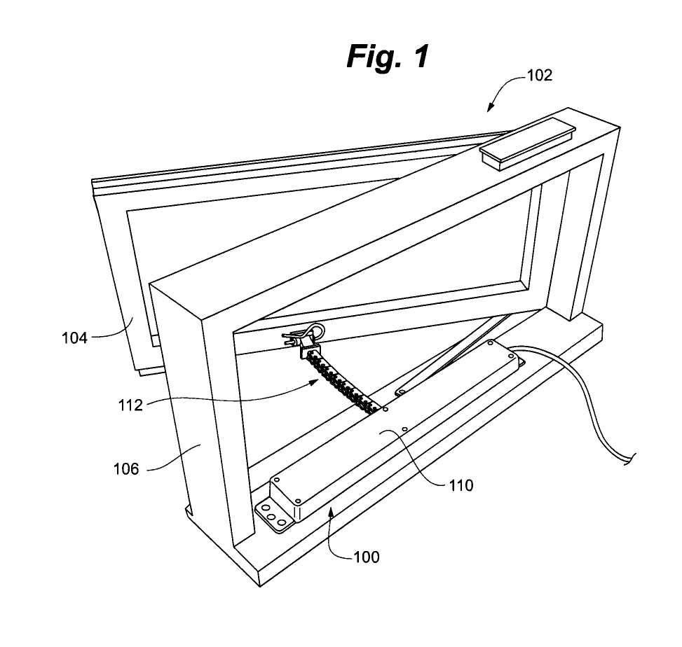

Referring now to FIGS. 1-11, there is depicted chain operator 100 for an operable window 102 according to an example embodiment of the invention. Operator 100 generally defines chain aperture 108 and includes housing assembly 110, a drive assembly 111 contained in the housing assembly 110 and drive chain 112 that can be extended from or retracted into the housing assembly 110 by the drive assembly.

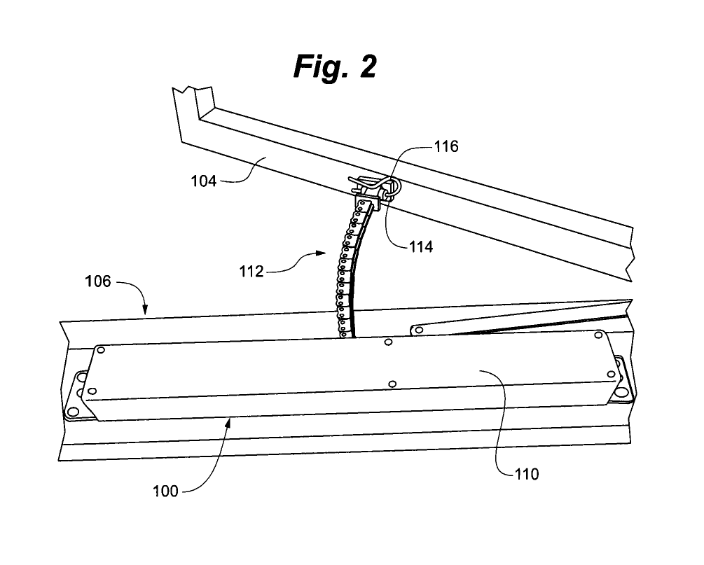

Operator 100, depicted generally in FIGS. 1 and 2, is mounted for operation of window 102, having sash 104 hinged to frame 106. Note that operator 100, as depicted, is mounted on a side of frame 106 that is perpendicular to hinge axis 113.

Drive chain 112 is coupled to bracket 114 with pin 116, or other appropriate fastener, thereby enabling drive chain 112 to be removably coupled to bracket 114. Bracket 114 is attached to a location on the sash 104, proximate a mid-point along sash 104 displaced from hinge axis 113, such that a length of drive chain 112 extendable outwardly from the operator 100 is sufficient to achieve a desired range of travel when opening the window.

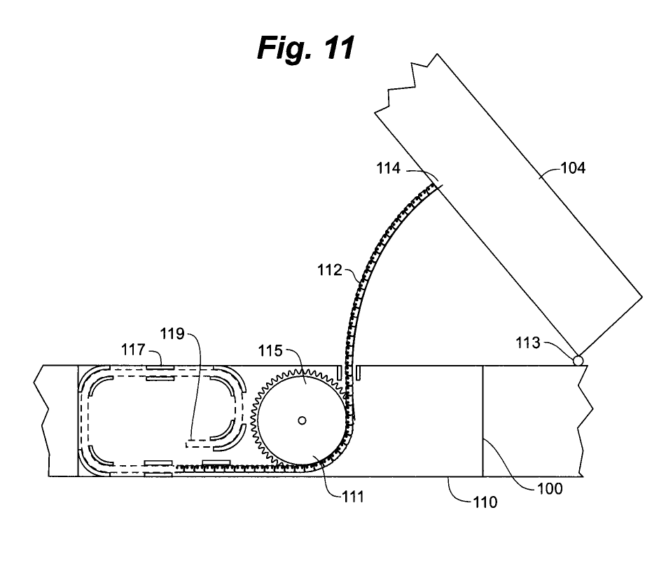

As depicted schematically in FIG. 11, housing assembly 110 of chain operator 100 generally includes drive assembly 111 including an actuating mechanism, such as an electric motor (not depicted) coupled with drive sprocket 115, configured to extend and retract drive chain 112. Housing assembly 110 generally includes a guide track 117 where a substantial length of drive chain 112 can be stored within housing assembly 110. When drive chain 112 is extended from housing assembly 110 through counter-clockwise rotation of drive sprocket 115, drive chain 112 urges window sash 104 outwardly from frame 106, pivoting window sash 104 about hinge 113 to open the window. As drive chain 112 extends, end 119 of drive chain 112 opposite the end connected to bracket 114 is drawn through guide track 117.

Conversely, window sash 104 can be closed by clockwise rotation of drive sprocket 115, which retracts drive chain 112 back into housing assembly 110. Drive chain 112 pulls window sash 104 inwardly toward frame 106, pivoting window sash 104 in the opposite direction about hinge 113 to close the window.

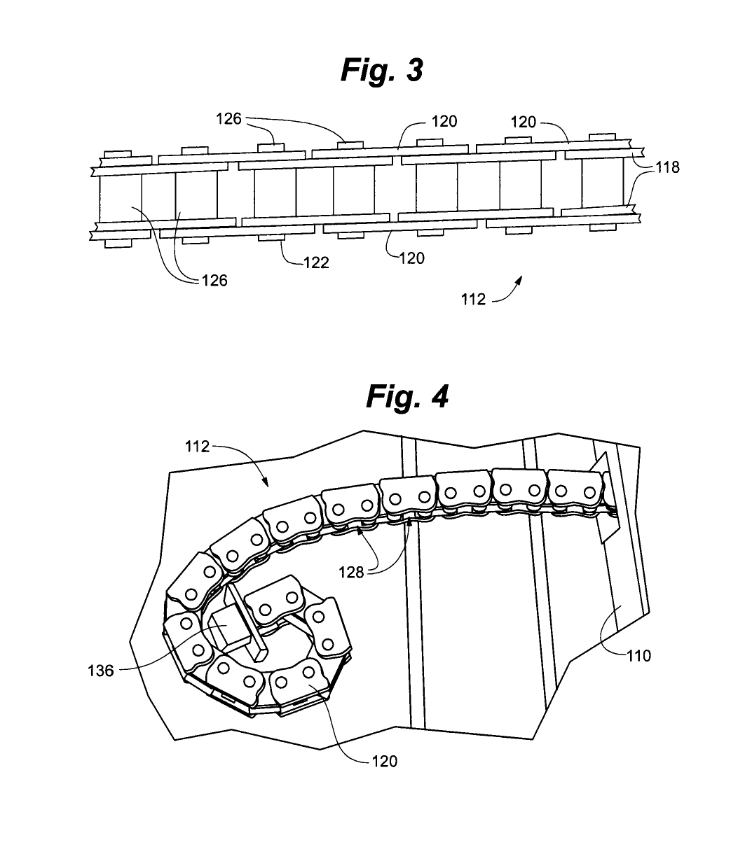

Referring to FIG. 3, an example embodiment of drive chain 112 includes inner link 118, shape-defining plates 120 and pins 122. Inner link 118 includes inner plates 124 and bushings 126. Inner link 118 includes two inner plates 124 separated by two bushings 126. Bushings 126 can be equipped with rollers (not depicted) surrounding bushings 126.

One of inner link 118 of drive chain 112 is connected to another similar inner link 118 by shape-defining plates 120. Pins 122 pass through appropriately sized apertures formed in shape-defining plates 120 and similar sized apertures (not shown) through inner plates 124 and the bushings 122 between the inner plates 120. Pins 126 provide a pivotable coupling between inner links 118 and shape-defining plates 120 allowing inner links 118 and shape-defining plates 120 to move relative to each other. When viewed as in FIG. 3, drive chain 112 generally resembles a roller chain such as that found on a common bicycle. An example of a roller chain with a connecting link is disclosed in U.S. Pat. No. 3,847,031 to Araya, which is incorporated by reference herein.

Inner plates 124 can be similar in shape and size to shape-defining plates 120. In an alternate embodiment, inner plates 124 may have uniformly rounded ends, as typically seen in a common roller chain. In this alternate embodiment, inner plates 120 can be narrower than shape-defining plates 124.

Notable features of the depicted embodiments are visible in the structure of shape-defining plate 120 as depicted in FIGS. 4-7. In one example embodiment, shape-defining plate 120 generally presents curved side 128, flat side 130, concave edge 132 and convex edge 134. The configuration of shape-defining plates 120 enable drive chain 112 to coil or bend freely towards curved side 128 such that drive chain 112 can be manipulated in wide range of motion toward curved sides 128 enabling drive chain 112 to be wound tightly as can be seen in FIG. 4. This flexibility further enables drive chain 112 to be manipulated for storage in a compact space present within housing assembly 110. FIG. 4 illustrates this flexibility by depicting drive chain 112 coiled.

Curved side 130 of shape-defining plate 120 is present on the side of drive chain 112 that is presented to drive sprocket 115. Drive sprocket 115 engages bushings 126 to extend and retract drive chain 112 as previously described.

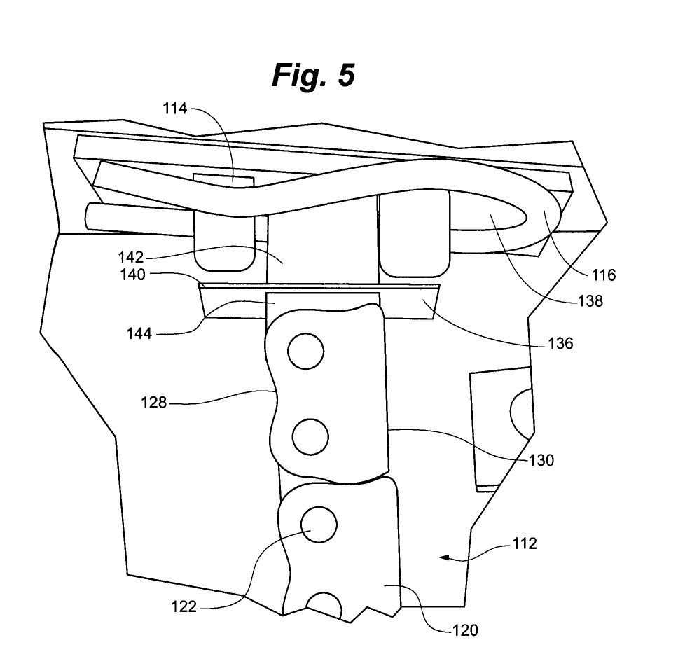

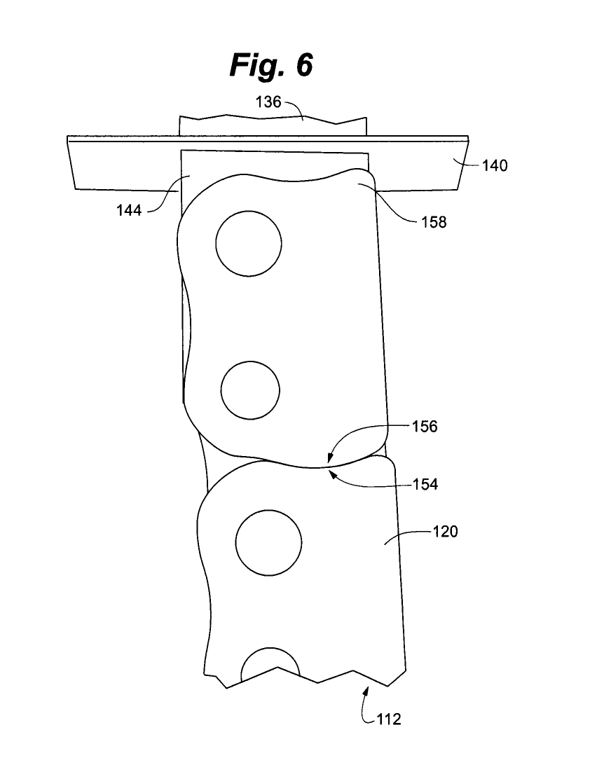

FIGS. 5 and 6 depict an embodiment of end connector 140 coupled to bracket 114 by pin 116. As depicted, bracket 114 is fixed to sash 104 by wood screws 138. Other fasteners may be used depending on the type of component materials.

End connector 136 generally includes retainer 140, sash portion 142 and chain portion 144. Retainer 140 is located between the sash portion 142 proximate to sash 104 and chain portion 144 of the end connector 140 coupled to the chain 112. Chain portion 144 includes chain interface 146. Chain interface 146 is structured to have a similar shape to convex edge 134 of shape-defining plate 120 to interface with concave edge 132 of outer plate 120 of drive chain 112 to limit the range of motion of outer plates 124 relative to end connector 140 when the chain 112 is flexed towards the flat side 130 but to allow freedom of motion toward curved side 128 similar to the interaction of adjacent shape-defining plates 120.

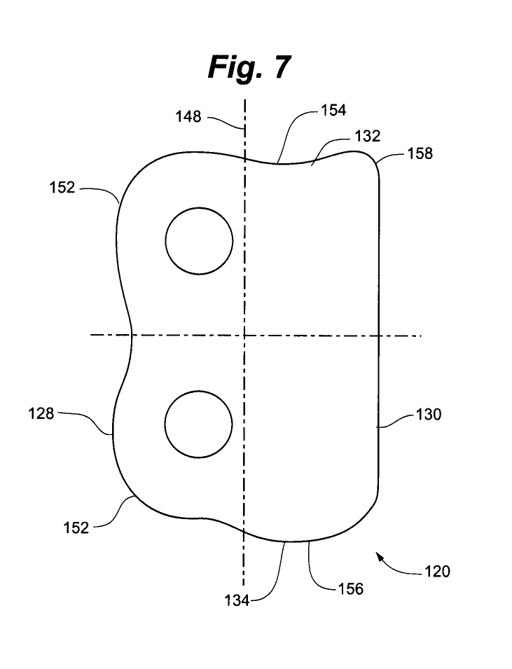

FIG. 7 depicts one embodiment of a perimeter defined by the shape-defining plate 120. As depicted, the perimeter of shape-defining plate 120 includes curved side 128 opposite straight side 130. Curved sides 128 and straight side 130 are approximately parallel to central axis 148 of shape-defining plate 120. Central axis 148 extends along the longer dimension of shape-defining plate 120. Concave edge 132 and convex edge 134 are approximately perpendicular to longer central axis 148 of shape-defining plate 120. Two apertures 150 penetrate shape-defining plate 120 closer to curved side of long axis 148. Pins 116 couple shape-defining plates 120 to inner plates 124 and bushings 126 to hold drive chain 112 together.

Shape-defining plate 120 further presents two smooth corners 152 on the curved side 128 of outer plate 124. Smooth corners 152 present generally constant radius arcs of roughly ninety degrees centered on each of two apertures 150. This configuration is consistent with a typical roller-type chain link and the capability of drive chain 112 to provide a free range of motion towards curved side 128.

Concave edge 132 and convex edge 134 present depression 154 and protrusion 156 respectively. Depression 154 and protrusion 156 are located nearer to flat side 130 than to curved side 128. Shape-defining plate 120 also presents lip 158 on the corner abutting both flat side 130 and concave edge 132. When drive chain 112 bends towards flat side 130 the motion of drive chain 112 is limited by the interaction of concave edge 132 and convex edge 134. In particular, concave edge 132 of each shape-defining plate 120 comes into abutting contact with the convex edge 134 of an adjacent shape-defining plate 120, thereby inhibiting further bending of drive chain 112 toward flat side 130. It will be appreciated that by altering the geometry of concave edge 132 and convex edge 134 of adjacent shape-defining plates 120, it is possible to pre-determine an angular relationship between adjacent links of drive chain 112 when drive chain 112 is bent in the direction toward flat side 130 and concave edge 132 and convex edge 134 of the adjacent links are in abutting contact.

Hence, in an example embodiment, the smooth corners 152 of shape-defining plates 120 enable free bending of drive chain 112 in the direction toward curved side 128, while the abutting contact of concave edge 132 and convex edge 134 of adjacent shape-defining plates 120 when drive chain 112 is bent in the direction toward flat side 130, causes drive chain 112 to form an essentially rigid bar-like structure having a pre-defined uniform arc or other shape dictated by the geometry of shape-defining plates 120.

The depicted structure of shape-defining plate 120 is an example embodiment. Many configurations of shape-defining plate 120 can be used by one of ordinary skill in the art to accomplish the abutment of the edges of shape-defining plates 120 that will create the desired rigidity of drive chain 112 when extended.

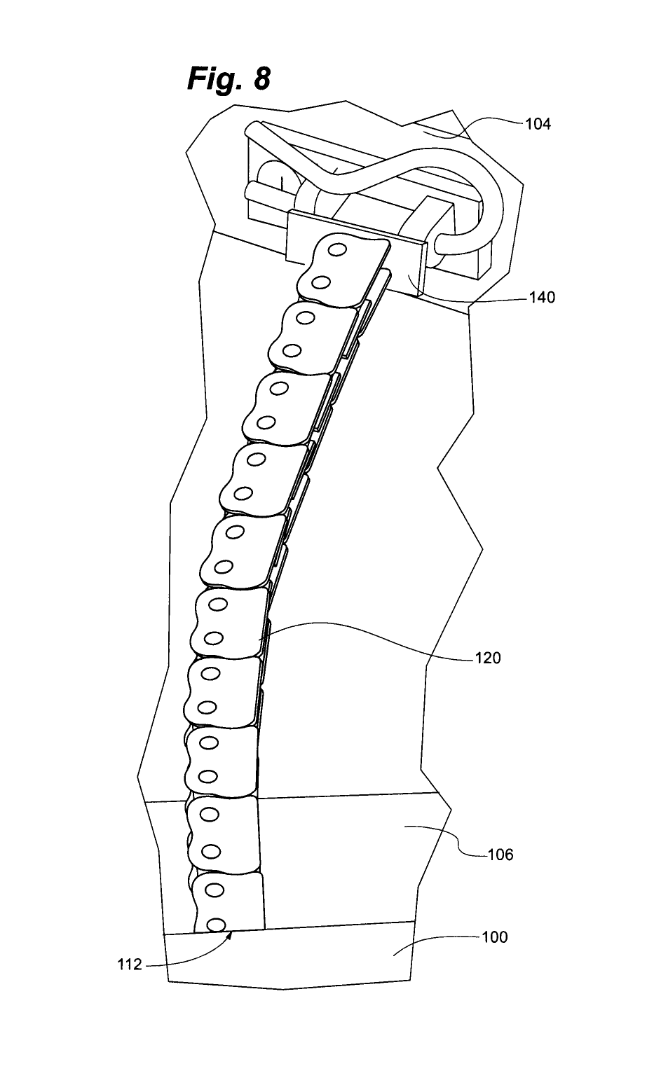

Referring to FIG. 8, in an example embodiment, the restricted motion caused by abutment of concave edges 132 and convex edges 134 causes drive chain 112 to attain a rigid, uniform arc between operator 100 and sash 104 as drive chain 112 extends from operator 100. The rigid arc in this example is generally centered at hinge axis 113 between sash 104 and frame 106. As drive chain 112 extends from operator 100 at a slightly obtuse angle, individual shape-defining plates 120 abut each other as concave edge 132 and convex edge 134 of adjacent shape-defining plates 120 come into contact with each other. Lip 158 of the link formed by shape-defining plate 120 coupled to end connector 136 contacts chain interface 146.

One advantage of drive chain 112, in accordance with the invention, is that while in the extended position relative to frame 106 oscillation or movement of window sash 104 is minimized due to the rigid condition of drive chain 112 in the extended position. When extended, drive chain 112 of the invention is surprisingly rigid.

In operation, operator 100 is secured to frame 106 of window assembly 102. A distal end of drive chain 112 is coupled to sash 104 by bracket 114. The proximal end of drive chain 112 is received in chain track in housing assembly 110 through chain aperture 108. The extension and retraction of chain 112 shifts sash 104 position relative to frame 106 to open and close sash 104.

Drive sprocket 115 rotates in first direction to extend drive chain 112 and in a second direction to retract drive chain 112. As drive chain 112 is extended, concave edges 132 of one shape-defining plate 120 abut convex edges 134 of adjacent shape-defining plates 120. When concave edges 132 of one shape-defining plate 120 abut convex edges 134 of adjacent shape-defining plates 120 drive chain 112 assumes a rigid structural configuration in part because pins 122 and bushings 126 are displaced laterally from central axis 148 of shape-defining plates 120. This arrangement causes pins 122 and bushings 126 to be under tension while abutting portions of shape-defining plates 120 nearer to flat side 130 are under compression. This makes for a very rigid structure when drive chain 112 is extended.

When drive chain 112 is retracted and passed over sprocket 115 portions of shape-defining plates 120 nearer to flat side 130 are placed under tension and drive chain 112 readily coils for compact storage.

By varying the shape of concave edges 132 and convex edges 134 of shape-defining plates 120 in the present invention the rigid shape that drive chain 112 assumes upon extension can be made to vary to other shapes beyond an arcuate curve. In the embodiment depicted in FIGS. 1-8, drive chain 112 assumes a uniform arcuate configuration having a radius approximating the distance from the location at which drive chain 112 is secured to sash 104 to hinge axis 113.

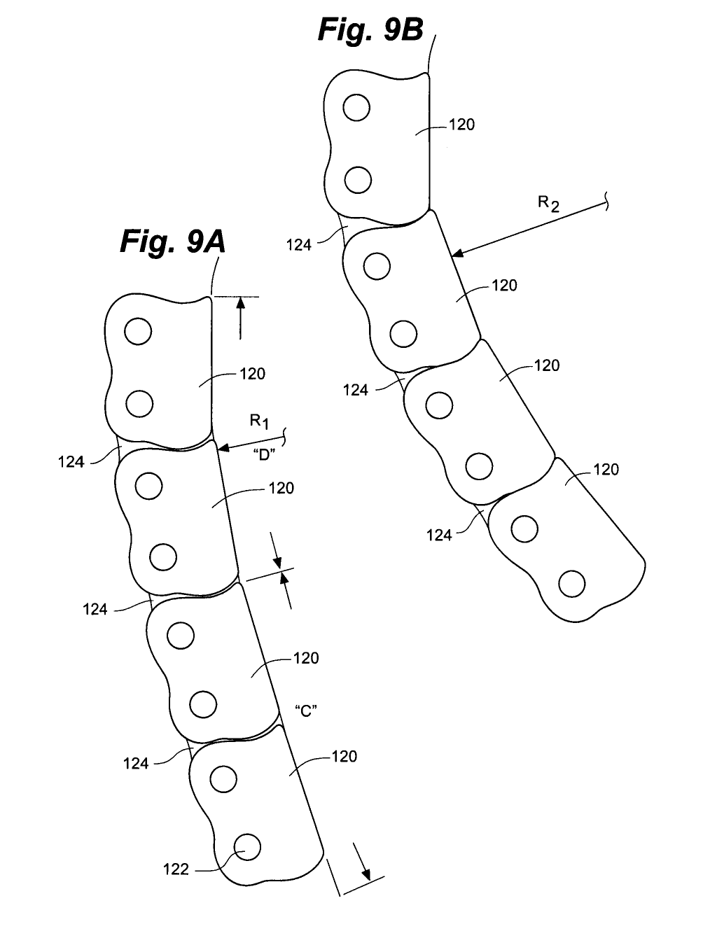

FIGS. 9A and 9B depict two different chain segments that may be used as a part of drive chain 112. In the FIG. 9A embodiment, segment C is substantially straight, and adjacent segment D is curved along an arc of a circle having a relatively large radius R₁. In the FIG. 9B embodiment, the depicted segment is uniformly curved along an arc of a circle having a smaller radius R₂, such that the curvature of the chain is more dramatic.

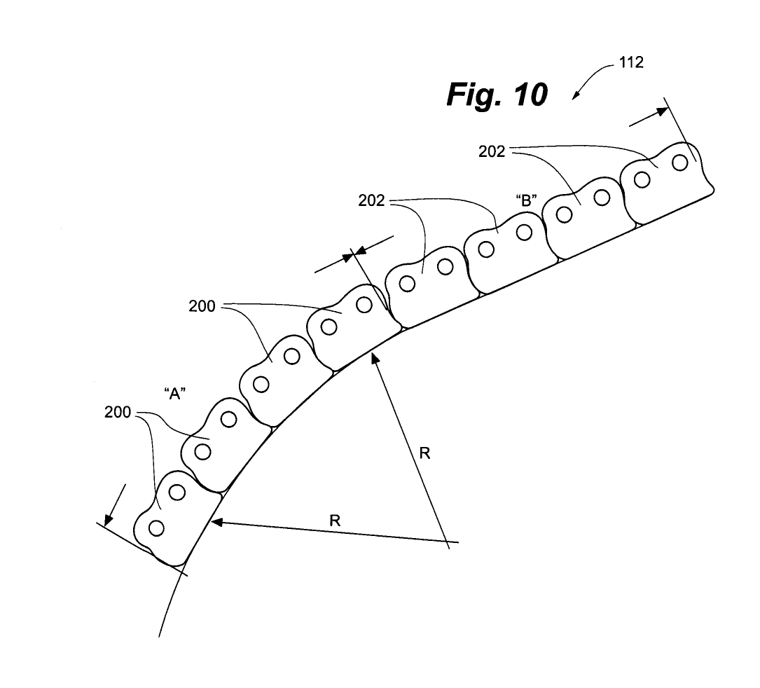

As depicted in FIG. 10, drive chain 112 may assume an irregular path that includes segments having greater curvature and other segments have lesser or no curvature. Such configurations can be accomplished by altering the geometry of the abutting edges of adjacent shape-defining plates 120. In the embodiment of FIG. 10, chain segment A has a regular curvature defining an arc of a circle with radius R, the curvature being predetermined with appropriate shape-defining plates 200. Chain segment B is substantially straight with no curvature as defined with different shape-defining plates 202.

In other embodiments, the shape of drive chain 112 can be made to conform to an irregular sash opening path to enable to the best geometry for positioning weather stripping between sash 104 and frame 106. This can improve the weather tightness and energy efficiency of window 102 or a skylight and reduce wear on weather stripping created by abrasion between the weather stripping and the surface that it seals against by reducing sliding of the weather stripping relative to the sealing surface.

While shape-defining plates 120 are depicted and described as abutting structures it is to be understood that a similar construction of inner plates 124 may also be part of the invention. Further the particular shapes of abutting structures of shape-defining plates 120 should not be considered limiting as other shapes may be used and are a part of the invention.

The foregoing descriptions present numerous specific details that provide a thorough understanding of various embodiments of the invention. It will be apparent to one skilled in the art that various embodiments, having been disclosed herein, may be practiced without some or all of these specific details. In other instances, components as are known to those of ordinary skill in the art have not been described in detail herein in order to avoid unnecessarily obscuring the present invention. It is to be understood that even though numerous characteristics and advantages of various embodiments are set forth in the foregoing description, together with details of the structure and function of various embodiments, this disclosure is illustrative only. Other embodiments may be constructed that nevertheless employ the principles and spirit of the present invention. Accordingly, this application is intended to cover any adaptations or variations of the invention. It is manifestly intended that this invention be limited only by the following claims and equivalents thereof.

Any incorporation by reference of documents above is limited such that no subject matter is incorporated that is contrary to the explicit disclosure herein. Any incorporation by reference of non-priority documents above is further limited such that no claims included in the documents are incorporated by reference herein and any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed:

1. A drive chain comprising:
a plurality of links, each link of the plurality of links pivotally coupled to at least one neighboring link of the plurality of links with a pin so as to form a chain; and
a plurality of shape-defining plates, each plate having a first edge and an opposing second edge, the plates coupled with the plurality of links such that the first edge of each plate is engaged with the second edge of a neighboring plate when the chain is flexed in a first direction, the engagement of the plates thereby defining a rigid predetermined shape for the chain.

2. The drive chain of claim 1, wherein the edges of the plates are disengaged when the chain is flexed in a second direction opposite the first direction, thereby enabling the chain to be coiled.

3. The drive chain of claim 1, wherein the shape-defining plates are coupled on the outside of the links with said pins.

4. The drive chain of claim 1, wherein the rigid predetermined shape is a uniform arm.

5. The drive chain of claim 1, wherein each of the pins is received in a bushing.

6. The drive chain of claim 1, wherein the first edge of each plate is convex and the second edge of each plate is concave.

7. A drive chain comprising:
a plurality of links, each link of the plurality of links pivotally coupled to at least one neighboring link of the plurality of links with a pin so as to form a chain; and
shape-defining means coupled with the links for defining a rigid predetermined shape for the chain when the chain is flexed in a first direction.

8. The drive chain of claim 7 wherein the shape-defining means comprises a plurality of shape-defining plates, each plate having a first edge and an opposing second edge, the plates coupled with the plurality of links such that the first edge of each plate is engaged with the second edge of a neighboring plate when the chain is flexed in the first direction.

9. The drive chain of claim 8, wherein the edges of the plates are disengaged when the chain is flexed in a second direction opposite the first direction, thereby enabling the chain to be coiled.

10. The drive chain of claim 8, wherein the shape-defining plates are coupled on the outside of the links with said pins.

11. The drive chain of claim 8, wherein each of the pins is received in a bushing.

12. The drive chain of claim 8, wherein the first edge of each plate is convex and the second edge of each plate is concave.

13. The drive chain of claim 7, wherein the rigid predetermined shape is arcuate.

14. An assembly for closing an opening in a structure, the assembly comprising:
a frame adapted to be received in the opening of the structure;
a movable sash hinged to the frame; and
a motorized operator assembly for moving the sash relative to the frame, the operator assembly including a drive chain comprising:
a plurality of links, each link of the plurality of links pivotally coupled to at least one neighboring link of the plurality of links with a pin so as to form a chain; and
a plurality of shape-defining plates, each plate having a first edge and an opposing second edge, the plates coupled with the plurality of links such that the first edge of each plate is engaged with the second edge of a neighboring plate when the chain is flexed in a first direction, the engagement of the plates thereby defining a rigid predetermined shape for the chain.

15. The assembly of claim 14, wherein the edges of the plates are disengaged when the chain is flexed in a second direction opposite the first direction, thereby enabling the chain to be coiled.

16. The assembly of claim 14, wherein the shape-defining plates are coupled on the outside of the links with said pins.

17. The assembly of claim 14, wherein the rigid predetermined shape is arcuate.

18. The assembly of claim 14, wherein each of the pins is received in a bushing.

19. The assembly of claim 14, wherein the first edge of each plate is convex and the second edge of each plate is concave.
